(19) United States
(12) Patent Application Publication
(10) Pub. No.: US 2015/0016761 A1
(43) Pub. Date: Jan. 15, 2015

(54) BEARING DEVICE FOR CONSTRUCTION MACHINE

(71) Applicant: Hitachi Construction Machinery Co., Ltd., Tokyo (JP)

(72) Inventors: Hideki Akita, Tsuchiura (JP); Shigeyuki Sakurai, Tsukuba (JP); Akiko Satou, Ushiku (JP); Osamu Gokita, Tsukuba (JP)

(21) Appl. No.: 14/372,311

(22) PCT Filed: Oct. 18, 2012
(86) PCT No.: PCT/JP2012/076907

§ 371 Date: Jul. 15, 2014

(30) Foreign Application Priority Data
Jan. 17, 2012 (JP) 2012-006873

(51) Int. Cl. F16C 27/02; F16C 33/10; F16C 33/74

(52) U.S. Cl. CPC F16C 27/02; F16C 33/74; F16C 33/102
USPC 384/125; 384/130

(57) ABSTRACT

The invention pertains to a bearing device used for a connecting part of a construction machine. The bearing device has: a boom having a boss part; an arm having left and right brackets that sandwich the boss part from the left and right sides thereof; a bush that is retained by an inner peripheral side of the boss part; a sealing that is disposed between the bush and the left and right brackets and that prevents a lubricant from leaking out of the bush; a thrust plate inserted between the left and right brackets and the boss part; and a coupling pin that penetrates and is inserted through the left and right brackets and the bush. The thrust plate has a partially cut out annular shape and an angle of a cut-out portion in the circumferential direction is less than 180° at an inner peripheral portion.

### FIELD OF THE INVENTION

The present invention relates to a construction machine and more particularly, a bearing device for construction machine which is suitable for use in connecting part of a boom or an arm of the construction machine.

### BACKGROUND OF THE INVENTION

The construction machine such as a hydraulic excavator is provided with bearing devices for rotatably interconnecting a boom, an arm, a bucket and the like which constitute a front working mechanism. The bearing device mounted in this front working mechanism typically includes: a boss member defined by one end of the boom or the arm, an inner periphery of which is fitted with a bush; and a bracket defined by an end of the armor the bucket that is connected with this boss member. A pair of left and right brackets is disposed lateral to the boss member and these elements are rotatably connected together by means of a coupling pin.

An example of the connecting part of a conventional construction machine having such a bearing device is set forth in Patent Literature 1. According to the construction machine disclosed in this publication, an axial clearance formed between two members at a connecting part is adjusted with a clearance adjusting plate when the two members such as an arm and a boom are rotatably connected with each other. This adjusting plate is formed of an elastic plate and a metal plate having adhesive property. The adjusting plate has an uninflected flat configuration and is formed with a U-shaped cut-out portion extended from the center of the plate to a peripheral part thereof. Further, the axial clearance is adjusted by insertably assembling the cut-out portion on the coupling pin.

Another example of the bearing device for construction machine is set forth in Patent Literature 2. A bearing device according to this publication is directed to suppress backlash caused by a radial clearance between a hole formed in a bracket and a pin inserted through this hole and to reduce resultant vibrations. That is, the bearing device is adapted for elastic support by inserting an elastic cylinder body between a part of the bracket and the pin and is also configured to set the radial clearance between the bracket portion without the elastic cylinder body and the pin smaller than the maximum elastic deformation of the elastic cylinder body.

An example of a pin connecting part of the construction machine is set forth in Patent Literature 3. This publication illustrates an example of a pin connecting part between an arm and a bucket. The pin is inserted through a distal end of the arm and brackets of the bucket for rotatably coupling the two members, the distal end of the arm placed on the inner side and the brackets placed on the outer sides. On this occasion, a clearance formed in the pin insertion direction is adjusted with a shim.

### CITATION LIST

### Patent Literature

Patent Literature 1: Japanese Unexamined Utility Model Application Publication No. Hei 2-11852/1990

Patent Literature 2: Japanese Unexamined Patent Application Publication No.2001-330024

Patent Literature 3: Japanese Unexamined Patent Application Publication No.2004-204650

### SUMMARY OF THE INVENTION

### Technical Problem

In the case where the boss member is disposed between the left and right brackets and coupled with the brackets by means of the pin, the above-described conventional bearing devices use means such as the thrust plate or the shim for adjusting the clearance formed as a difference between the distance between the left and right brackets and the axial length of the boss member, thus preventing the invasion of foreign substance such as earth and sand through the formed clearance or frictional wear associated with vibration noises.

As for the pin connecting part of Patent Literature 1 where the clearance adjusting plate is used, for example, the U-shaped cut-out portion formed in the clearance adjusting plate permits the insertion of the clearance adjusting plate for clearance adjustment at a job site after inserting the pin through the brackets and the boss member. However, Patent Literature 1 does not give due consideration to fear that in a case where the clearance adjusting plate according to this publication is used, the clearance adjusting plate may fall off from the pin due to an impact force or the like occurring at the job site. In conjunction with the long-term use of the construction machine, the individual components are expected to sustain minor deformations, which may also lead to the increase in the axial clearance at the pin connecting part. Therefore, if a circumferential position of the U-shaped cut-out portion is at an upper part of the circumference, the clearance adjusting plate may fall off from the pin due to the gravity or impact force.

In the bearing device according to Patent Literature 2, the bracket to retain the pin is configured to absorb the radial clearance between the pin and the bracket by means of the elastic cylinder body and hence, the pin is fixed to place and the noises or frictional wear can be reduced. However, this publication does not disclose any feature regarding the axial clearance between the bracket and the boss member or does not give due consideration to fear that the bracket may be axially displaced to cause the noises or frictional wear.

Further, the structure of the pin connecting part according to above-described Patent Literature 3 is adapted to absorb the clearance formed between the bracket and the boss member by previously arranging the shim member in place and assembling the connecting part. The shim member used in the pin connecting part according to this publication is made deformable, offering an advantage that the bracket and the boss member can be assembled together by inserting the pin therethrough. However, the shim member is complicated in structure in order to be deformable, involving complicated handling in assembly and requiring increased assembly manhours.

In view of the above disadvantages of the prior arts, the invention is accomplished and has an object to provide a pin connecting part of construction machine which has a simple structure adapted to absorb the axial clearance formed between the bracket and the boss member. Another object of the invention is to provide a pin connecting part of construction machine which is configured to absorb the above clearance after the pin is inserted through the brackets and the boss member and fixed in place. Namely, the invention is directed to improve assembly workability of the bearing device by providing a simple structure which is adapted for clearance absorption through assembly adjustment at the job site and which negates the need for previously measuring assembling clearance and the like.

### Solution to Problem

According to an aspect of the invention for achieving the above objects, a bearing device for use in a connecting part of a construction machine including: a lower travelling body, an upper turning body mounted on the lower travelling body, and a front working mechanism mounted on the upper turning body, the bearing device includes: a first member having a boss part; a second member having left and right brackets sandwiching the boss part on opposite lateral sides thereof; a bush retained on an inner periphery of the boss part; sealing means interposed between the bush and each of the left and right brackets and preventing a lubricant medium from leaking from the bush; a thrust plate inserted between each of the left and right brackets and the boss part; and a coupling pin inserted through the left and right brackets and the boss part, and features a structure wherein the thrust plate is formed by cutting out a part of an annular body and is configured to be insertably assembled on the coupling pin after insertion of the coupling pin through the left and right brackets, and wherein a circumferential angle of the cut-out portion of the thrust plate as determined on the inside circumference thereof is equal to or less than 180°.

According to the aspect of the invention, the thrust plate may be formed with a hole that makes the thrust plate elastically deformable, the hole located in the vicinity of the cut-out portion and an inflection point at which an arc of the inside circumference changes to a curve of the cut-out portion. The thrust plate may also be formed with a hole in the vicinity of a minimum gap portion, the hole that makes the thrust plate deformable in a planar direction.

According to the above aspect of the invention, it is preferred that the thrust plate is formed with a plurality of dimples on at least one surface thereof. Otherwise, the thrust plate may also be formed with at least one slit extending radially outward from an inner periphery of the thrust plate.

### Advantageous Effects of Invention

According to the invention, the bearing device for construction machine is adapted to absorb the axial clearance between the bracket and the boss member by means of the thrust plate formed of a flat plate capable of elastic deformation in the planar direction. Therefore, the clearance can be absorbed even after the bracket and the boss member are pin-connected and hence, the bearing device is improved in assembling workability.

### BRIEF DESCRIPTION OF DRAWINGS

FIG. 1 is a side view showing a construction machine according to one embodiment of the invention;

FIG. 2 is a vertical sectional view showing a bearing device for the construction machine shown in FIG. 1 according to one embodiment of the invention;

FIG. 3 is a front view showing a thrust plate for use in the bearing device of FIG. 2;

FIG. 4 is a group of front views showing thrust plates for use in the bearing device of FIG. 2 according to other embodiments of the invention; and

FIG. 5 is a group of sectional views of the thrust plates shown in FIG. 4.

### DESCRIPTION OF EMBODIMENTS

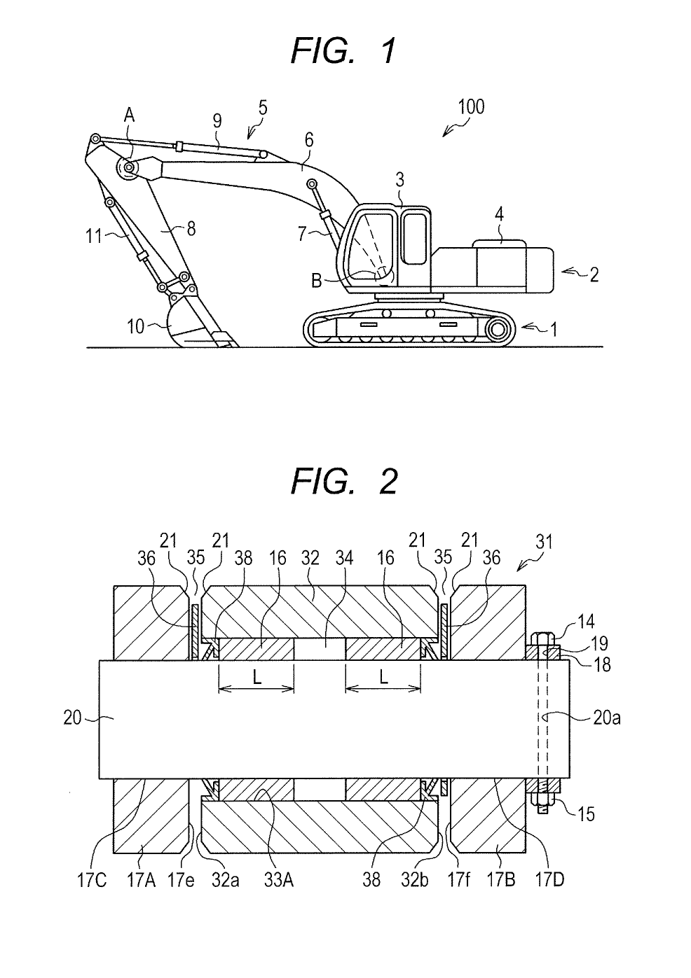

Construction machines according to various embodiments of the invention will hereinbelow be described with reference to the accompanying drawings. FIG. 1 is a side view showing a construction machine 100 according to one embodiment of the invention.

The construction machine 100 is, for example, a hydraulic excavator which includes: a lower travelling body 1 equipped with a crawler belt; and an upper turning body 2 turnably mounted on this lower travelling body 1. Disposed between the lower travelling body 1 and the upper turning body 2 is a turning device for controlling the rotation of the upper turning body 2. In the upper turning body 2, a cabin 3 for an operator to get in and to operate the construction machine is disposed at a front part thereof while a machine room 4 housing an engine and a hydraulic pump for driving and controlling this working machine is disposed at a rear part thereof.

A front working mechanism 5 is mounted to the front of the upper turning body 2 in a manner to be capable of tilt up and down. The front working mechanism 5 includes: a boom 6 having a proximal end pin-connected to the upper turning body 2; an arm 8 also pin-connected to an opposite end of this boom 6 from the proximal end thereof; and an attachment 10 such as a bucket that pin-connected to a tip end of the arm 8 and used for excavation or the like. These boom 6, arm 8 and bucket 10 are provided with a hydraulic actuator, such as boom cylinder 7, arm cylinder 9 and bucket cylinder 11, respectively.

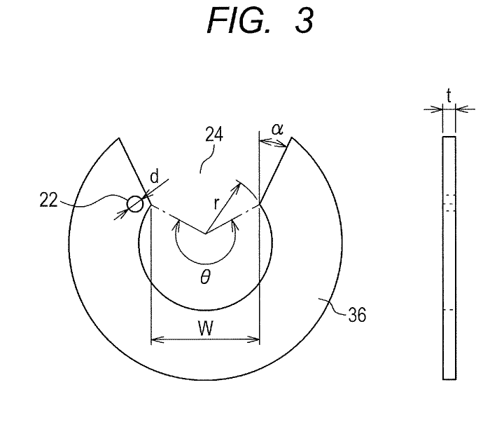

For rotation of the boom 6 or the arm 8 by operating the boom cylinder 7 or the arm cylinder 11, a bearing device 31 is disposed in a connecting part B between the proximal end of the boom 6 and the upper turning body 2; a connecting part A between the opposite end of the boom 6 and an end of the arm 8 or a mount portion of the bucket 10. FIG. 2 shows the details of the bearing device 31 in vertical section.

FIG. 2 is a detail view of the part A in FIG. 1. The part B in the above figure is configured the same way. A tip end of the boom 6 is extended into left and right brackets 17A, 17B in a fork-like fashion so as to be connected with the arm 8. These left and right brackets 17A, 17B sandwich therebetween a boss part 32 disposed at an end of the arm 8.

The left and right brackets 17A, 17B are formed with through-holes 17C, 17D to permit the boss part 32 of the arm 8 to be rotatably connected to the boom 6. A coupling pin 20 is inserted through the left and right through-holes 17C, 17D. This coupling pin 20 also penetrates the arm 8, or slidably inserted through an inner periphery of a boss-side bush 16 to be described hereinlater. In order to prevent the coupling pin 20 from falling off from the left and right brackets 17A, 17B, a bush 18 formed with a hole to be fitted with the coupling pin 20 is welded to an outer side of one bracket 17B.

The bush 18 and the coupling pin 20 are formed with a though-hole 19 and a release stop hole 20a, respectively, which penetrate the bush and the coupling pin in a direction perpendicular to an axial direction. A bolt 14 is inserted in these through-hole 19 and release stop hole 20a and is screwed up by a nut 15. Thus, the coupling pin 20 is fixed in place in a manner to be prevented from falling off from or rotating relative to the brackets 17A, 17B.

The boss part 32 of the arm 8 is substantially formed in a cylindrical shape. An inner peripheral surface of the boss part 32 of the arm 8 defines a fitting hole 33A, which is fitted with two boss-side bushes 16 formed of a hard material such as chrome molybdenum steel or oil-impregnated sintered metal. The boss-side bushes 16 have an axial length L and are axially spaced from each other. An axial gap between the boss-side bushes 16, 16 defines a grease pool 34 which is externally supplied with grease via an unillustrated grease supply passage. The inner peripheral surface of the boss-side bush 16 defines a sliding surface for the coupling pin 20 as described above.

A sealing member 38 is disposed between each of the opposed surfaces of the left and right brackets 17A, 17B and end face of each of the boss-side bushes 16, 16. The sealing member 38 is composed of a contact type seal such as an oil seal and serves to prevent the leakage of the grease migrating from the grease pool 34 to a sliding portion between the boss-side bush 16 and the coupling pin 20.

It is noted here that a distance between the opposed surfaces of the left and right brackets 17A, 17B is slightly longer than an axial length of the boss part 32 of the arm 8 so that a clearance 35 is formed between each of the left and right brackets 17A, 17B and the boss part 32. Specifically, the clearance 35 is formed for the sake of improving the ease of the connecting part assembly and bearing a thrust force (force acting in the axial direction of the coupling pin 20) applied to the front working mechanism 5 including the arm 8 and the boom 6. Inserted in this clearance 35 is a thrust plate 36 which constitutes a feature of the invention the details of which will be described hereinlater. Both surfaces of this thrust plate 36, axial end faces 32a, 32b of the boss part 32 of the arm 8, and the left and right brackets 17A, 17B cooperatively act as a thrust bearing.

By the way, the conventional assembly process includes the steps of: forming an annular thrust plate from urethane rubber or polyethylene; inserting the bush in the boss part of the arm; and inserting the coupling pin in the boss part of the arm and the brackets so as to couple the boss part of the arm with the brackets. Therefore, it is difficult to adjust the axial clearance formed between the bracket and the boss part of the arm or between the bracket and the bush. Hence, an excessive clearance used to result in axial vibrations or frictional wear.

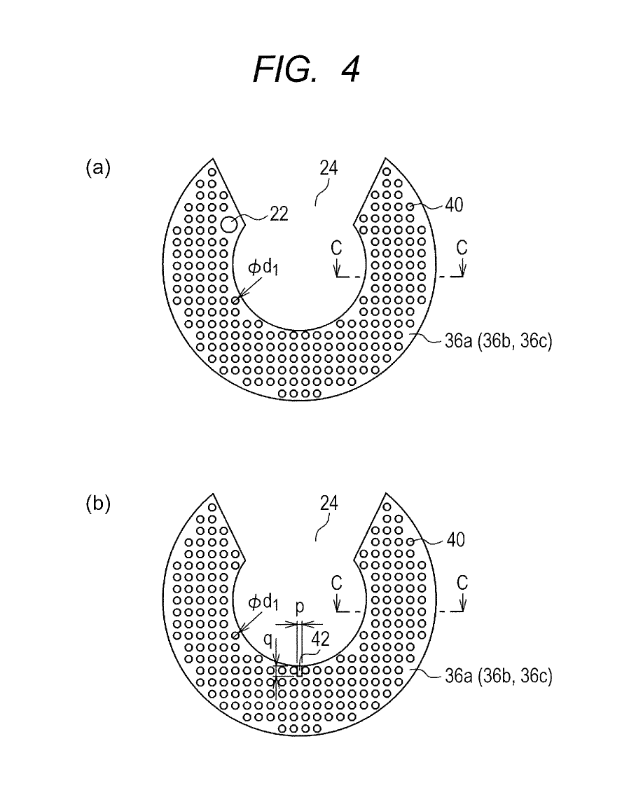

In order to solve this drawback, the thrust plate 36 of the invention is configured as follows. As shown in FIG. 3 to FIG. 5, the thrust plate 36 disposed on an axially inner side of each of the left and right brackets 17A, 17B is formed in a shape obtained by cutting out a circumferential portion from an annular material. After the left and right brackets 17A, 17B and the boss part 32 of the arm 8 are connected together by means of the coupling pin 20, the thrust plate 36 formed in this manner is hammered in between the boss part and the bracket from the cut-out portion thereof. Therefore, chamfers 21 are formed at outer peripheral corners of the left and right brackets 17A, 17B and the boss part 32 of the arm 8, ensuring smooth insertion of the thrust plate 36 and improvement of hammering activity.

The thrust plate 36 shown in FIG. 3 is shaped from heat treated steel material having a thickness t, followed by surface treatment such as nitriding. The thickness t is decided according to the clearance 35 formed after assembling the coupling pin 20, or on the order of 1 mm. The thrust plate 36 has an inside diameter 2r which is slightly larger than an outside diameter dₒ of the coupling pin 20. The cut-out portion 24 has dimensions such that a width W at a minimum gap portion is slightly smaller than the inside diameter 2r of this thrust plate 36 and is further smaller than the diameter dₒ of the coupling pin. Therefore, the thrust plate excluding the cut-out portion 24 has an overall circumferential angle θ>180°. The arc changes to a linear portion at the minimum gap portion, which defines an inflection point.

More specifically, the thrust plate 36 is configured such that when this thrust plate 36 is insertably assembled on the coupling pin 20, the corners of the minimum gap portion (width W portion) undergoes deformation within an elastic range but are not deformed so much as to be in a plastic deformation range. The following effect is obtained by limiting the deformation of the minimum gap portion in this range. Once the thrust plate 36 is insertably assembled on the coupling pin 20, the corners of the minimum gap portion (width W portion) restore from the elastic deformation to form a bottleneck which can prevent the thrust plate 36 from falling off from the coupling pin 20 even though the bearing device 31 is subjected to vibrations.

As described above, the thrust plate 36 employed by the invention is required to undergo the elastic deformation at the minimum gap portion (width W portion). Therefore, it is effective to make the corners of this minimum gap portion (width W portion) prone to elastic deformation. In order to promote the elastic deformation of the thrust plate 36, a small hole 22 having a diameter d is formed in the vicinity of the minimum gap portion (width W portion).

According to the bearing device 31 employing the thrust plate 36 shown in FIG. 3, the bearing device 31 is assembled by inserting the coupling pin 20 into the left and right brackets 17A, 17B. Subsequently, the thrust plate 36 is hammered in between the boss part 32 of the arm 8 and each of the left and right brackets 17A, 17B. In this process, the minimum gap portion (width W portion) of the thrust plate 36 is temporarily deformed to expand because the minimum gap portion (width W portion) of the thrust plate 36 is smaller than the diameter dₒ of the coupling pin 20. This expanding deformation is absorbed by the small holes 22 present in the vicinity of the minimum gap portion (width W portion). After passing a maximum diameter portion of the coupling pin 20, the thrust plate 36 restores from the elastic deformation due to internal stress occurring in the vicinity of the minimum gap portion (width W portion) so as to maintain the initial minimum gap W.

According to the above embodiment, the cut-out portion 24 is shaped like a fan which includes a rectangular cut-out and a sector cut-out with a central angle α on either side of the rectangular cut-out. However, the shape of the cut-out portion is not limited to the fan shape. The cut-out portion may have a rectangular shape in a case where importance is placed on bearing performance. However, the fan-shaped cut-out portion has advantage in permitting the thrust plate 36 to be hammered in place with less resistance. While the small hole 22 has a round shape, the small hole 22 is not limited to the round hole but may have an oval shape. Although the position of the small hole 22 is limited to the vicinity of the minimum gap portion (width W portion), the small hole need be spaced away from an end of the thrust plate 36 by a distance long enough to ensure that the small hole is not destroyed when this thrust plate 36 is insertably assembled on the coupling pin 20. Experimental results indicate that the small hole is desirably located slightly upward of the minimum gap portion (width W portion) as seen in FIG. 3.

Another embodiment of the invention is described with reference to

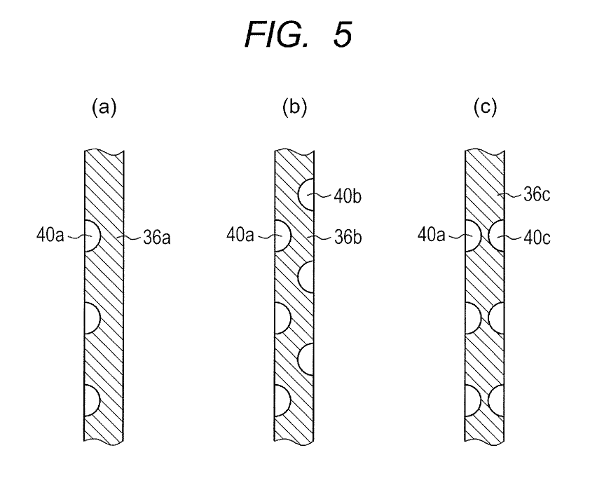

FIG. 4(a) and FIG. 5. This embodiment differs from the above embodiment in that a thrust plate 36a to 36c is evenly formed with minute pits (dimples) 40 (40a to 40c) on one surface or the both surfaces thereof. The dimples 40 are formed by impressing with ball, for example. The dimples may be arranged in a matrix form as shown in the figure, or may also be staggered array. The dimple 40 has a diameter of about 2 mm and a depth of about 0.2 mm.

FIG. 5(a) shows an example where the dimples 40 are formed only on one side. FIG. 5(b) and FIG. 5(c) each show an example where the dimples 40 are formed on the both surfaces. It is noted that FIG. 5(a) shows the dimples 40 on the front surface displaced from the dimples 40 on the back surface while FIG. 5(d) shows the dimples 40 on the front surface aligned with the dimples 40 on the back surface. The dimples 40 can be formed on the whole surface at a time by a press or the like. The reason for forming the dimples 40 is to allow the grease supplied from the grease pool 34 or previously applied to the surface to be retained on this thrust plate 36a to 36c for a long period of time.

In addition to the effects of the above embodiments, this embodiment offers an effect to allow the bearing device 31 to retain the grease for a long period of time. Similarly to the above embodiments, this embodiment is also adapted for the changes of configuration and location of the small hole 22, configuration of the cut-out portion 24 and the like. However, it is essential for the thrust plate to undergo the elastic deformation at the minimum gap portion.

Another embodiment of the invention is described with reference to FIG. 4(b) and FIG. 5. This embodiment differs from the above embodiments in that a slit 42 is formed in place of the small hole 22. The same thrust plate 36a to 36c as that used in the example shown in FIG. 4(a) is formed with the slit 42 having a width p and a length q on the opposite surface from the cut-out portion 24. Because of the formation of the slit 42, expansion of the cut-out portion of the thrust plate 36a to 36c first starts from the slit 42 when the thrust plate 36a to 36c is insertably assembled on the coupling pin 20. After the minimum gap portion of the thrust plate 36a to 36c slips on the coupling pin 20, the elastic force acts to restore the slit 42.

Once the thrust plate 36a to 36c is insertably assembled on the coupling pin 20, the thrust plate 36a to 36c is prevented from falling off from the coupling pin 20 even though the bearing device 31 is subjected to vibrations. Similarly to the embodiment shown in FIG. 4(a), this embodiment is also adapted for the changes of the configuration of the cut-out portion 24, the location of the dimples 40 and the like. While the position of the slit 42 is also changeable, preserving symmetry is more effective to induce uniform stress and to avoid breakage or the like of the thrust plate 36a to 36c.

According to the aforementioned embodiments, the thrust plates are improved in lubricability by virtue of the grease pool and the heat treatment or surface treatment of the thrust plate, achieving as high lubricability as resin-made thrust plates conventionally used in the art. What is more, the thrust plate reduces the axial clearance of the bearing device so that the bearing device is reduced in friction or wear. Further, the simple structure of the embodiments facilitates the assembling work, reducing the manhours and assembly manhours.

While the above embodiments have been described by way of example of the bearing device used in the connecting part between the arm and boom, the invention is not limited to the above-described portion but is applicable to a pin-connected bearing device as exemplified by a boom. base. While the above embodiments have been described by way of example of the hydraulic excavator, the invention is also applicable to other construction machines such as crane.

### REFERENCE SIGNS LIST

1 . . . lower travelling body, 2 . . . upper turning body, 3 . . . cabin, 4 . . . machine room, 5 . . . front working mechanism, 6 . . . boom (the first member), 7 . . . boom cylinder, 8 . . . arm (the second member), 9 . . . arm cylinder, 10 . . . bucket, 11 . . . bucket cylinder, 14 . . . bolt, 15 . . . nut, 16 . . . boss-side bush, 17A, 17B . . . brackets, 18 . . . bush, 19 . . . through-hole, 20 . . . coupling pin, 20a . . . release stop hole, 21 . . . chamfering, 22 . . . hole, 24 . . . cut-out portion, 31 . . . bearing device, 32 . . . boss part, 33A . . . fitting hole, 34 . . . grease pool, 35 . . . clearance (axial direction), 36, 36a-36c . . . thrust plates, 38 . . . sealing member, 40, 40a-40c . . . dimples, 42 . . . slit, 100 . . . hydraulic excavator (construction machine).

What is claimed is:

1. A bearing device for use in a connecting part of a construction machine including: a lower travelling body, an upper turning body mounted on the lower travelling body, and a front working mechanism mounted on the upper turning body, the bearing device comprising:
a first member having a boss part;
a second member having left and right brackets sandwiching the boss part on opposite lateral sides thereof;
a bush retained on an inner periphery of the boss part;
sealing means interposed between the bush and each of the left and right brackets and preventing a lubricant medium from leaking from the bush;
a thrust plate inserted between each of the left and right brackets and the boss part; and
a coupling pin inserted through the left and right brackets and the boss part,
wherein the thrust plate is formed by cutting out a part of an annular body and is configured to be insertably assembled on the coupling pin after insertion of the coupling pin through the left and right brackets, and
wherein a circumferential angle of the cut-out portion of the thrust plate as determined on the inside circumference thereof is equal to or less than 180°.

2. The bearing device for the construction machine according to claim 1, wherein the thrust plate is formed with a hole that makes the thrust plate elastically deformable, the hole located in the vicinity of the cut-out portion and an inflection point at which an arc of the inside circumference changes to a curve of the cut-out portion.

3. The bearing device for the construction machine according to claim 2, wherein the thrust plate is formed with at least one slit extending radially outward from an inner periphery of the thrust plate.

4. The bearing device for the construction machine according to claim 1, wherein the thrust plate is formed with a plurality of dimples on at least one surface thereof.

5. The bearing device for the construction machine according to claim 2, wherein the thrust plate is formed with a plurality of dimples on at least one surface thereof.

6. The bearing device for the construction machine according to claim 3, wherein the thrust plate is formed with a plurality of dimples on at least one surface thereof.
